(19) United States
(12) Patent Application Publication
(10) Pub. No.: US 2025/0119356 A1
(43) Pub. Date: Apr. 10, 2025

(54) SYSTEMS AND METHODS FOR IDENTIFYING WEAKNESS IN A NETWORK SYSTEM USING CHAOS ENGINEERING

(71) Applicant: Cisco Technology, Inc., San Jose, CA (US)

(72) Inventor: Ahmed Metwally, Haarlem (NL)

(21) Appl. No.: 18/481,730

(22) Filed: Oct. 5, 2023

(51) Int. Cl. H04L 41/14; H04L 41/0604

(52) U.S. Cl. CPC H04L 41/145; H04L 41/0627

(57) ABSTRACT

A method for identifying one or more weakness in a network system through simulations includes configuring a plurality of chaos events to be run on the network system, running the plurality of chaos events on the network system, receiving alert messages from a monitoring system, determining differences if the alert messages match with a set of expected alert messages and/or delay in receiving the alert messages, and reporting the determined differences to a control plane of the network system for display on a user terminal.

### DESCRIPTION OF THE RELATED TECHNOLOGY

The present disclosure relates generally to chaos engineering applied to network systems, and, more particularly, to identify weakness of the network systems by simulations combined with running tests with monitoring systems.

### BACKGROUND

A network system connects two or more computing devices and allows the computing devices to exchange data and share resources with each other. The network system uses a system of rules, called communication protocols, to transmit information over physical or wireless technologies. The network systems include connecting devices or components, including switches, routers, and wireless access points, among others. Through the connecting devices, the computing devices can be connected and can communicate with one another and with other networks, such as Internet.

### BRIEF DESCRIPTION OF THE SEVERAL VIEWS OF THE DRAWINGS

In order to describe the manner in which the above-recited and other advantages and features of the disclosure may be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example of a high-level network architecture in accordance with the present disclosure;

FIG. 2 illustrates an example of a network topology in accordance with the present disclosure;

FIG. 3 illustrates an example system configuration for performing chaos simulations and testing network system in accordance with present disclosure;

FIG. 4 illustrates an example method for identifying weakness in a network system weakness through simulations in accordance with the present disclosure;

FIG. 5 shows an example of a computing system for implementing certain aspects of the present technology; and

FIG. 6 illustrates an example network device in accordance with the present disclosure.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Description of Example Embodiments

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure may be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

The present technology identifies problems for network systems through chaos engineering simulations. The present technology also uses monitoring systems to generate alert messages. The simulations along with monitoring system allow for identification of weakness of the network systems and determination of resilience of the network systems.

The present technology uses a test application to perform simulations in various modes on actual system configurations. The system configurations can be done at times when the network traffic is low in order to prevent disruptions to users. The simulations and tests using monitoring system help determine what alert messages are reported and also determine if the alert messages match expectations and identify different points of failure in the network system.

In one aspect, a method for identifying one or more weakness in a network system through simulations includes configuring a plurality of chaos events to be run on the network system, running the plurality of chaos events on the network system, receiving alert messages from a monitoring system, determining differences if the alert messages match with a set of expected alert messages and/or delay in receiving the alert messages, and reporting the determined differences to a control plane of the network system for display on a user terminal.

In another aspect, a computing apparatus includes a processor. The computing apparatus also includes a memory storing instructions that, when executed by the processor, configure the apparatus to configure a plurality of chaos events to be run on the network system, run the plurality of chaos events on the network system, receive alert messages from a monitoring system, determine differences if the alert messages match with a set of expected alert messages and/or delay in receiving the alert messages, and report the determined differences to a control plane of the network system for display on a user terminal.

In a further aspect, a non-transitory computer-readable storage medium, where the computer-readable storage medium including instructions that when executed by a computer, cause the computer to configure a plurality of chaos events to be run on the network system, run the plurality of chaos events on the network system, receive alert messages from a monitoring system, determine differences if the alert messages match with a set of expected alert messages and/or delay in receiving the alert messages, and report the determined differences to a control plane of the network system for display on a user terminal.

### Example Embodiments

A network system may have weakness in design that may cause unexpected events affecting customers having critical services. For example, if a server in a network system may be unexpectedly reboot or may have an unexpected power outage, the unexpected event may affect customers having critical services and cause chaos to the customers. Another example, when a network traffic increases and a system load increases, network delay, packet loss, packet corruption, packet duplication may increase to a point such that customers having critical services become unsatisfied. There is a remaining need for identifying the weakness of the network system before the customers are affected by unexpected events or chaos events.

In a network system, the ability of the system to tolerate failures while still ensuring adequate quality of service is generalized as resilience. Chaos engineering can be used to achieve resilience against infrastructure failures, network failures, and server failures.

The present technology provides a technical solution to address the issues of identifying weakness in the network system by simulating chaos events in the network systems by using a test application. Simulations are done by scheduling various chaos events occurring at selected times. The simulations include varying the degrees of one, two or more chaos events simultaneously to push the system to failure while collecting data by monitoring systems, such as varying network traffic, stressing CPU or I/O operations by increasing CPU load and/or increasing I/O traffic, random rebooting, varying starting time or ending time, changing percentage of the packet corruption, changing the percentage of the packet loss and/or the percentage packet duplication. Then, the differences between the scheduled events and collected data are analyzed to help identify the weakness of the network system.

The simulations can vary through different modes including 1) system load increase, 2) network delay, 3) packet loss, 4) packet corruption, 5) packet duplication, 6) random reboots. Additionally, each of the selections can be manipulated for particular configurations.

The reports that are generated based on differences between the test application and the monitoring system may help identify one or more weakness in the network system. For example, certain processes may be run on a specific data center. The simulation provides information (e.g., alert messages) based on one or more variations of the parameters in the specific data center. The issues in the specific data center (e.g., random reboots of servers in the specific data center) may affect the performance of the network system outside the specific data center.

For network applications, the test application generates simulations of a number of pre-determined chaos events at one or more specified time and determines when entries of chaos events may occur. The monitoring system detects actual chaos events and generates reports of alert messages. Differences may be present between expected entries of chaos events and the actual chaos events. A delay in reporting of chaos events may be determined based on the difference between an expected time from the simulations and an actual time from the monitoring system. When the reporting of the chaos events is delayed, the network system may have a problem which can be fixed to prevent the delayed reporting issue from occurrence and to report the event in a timely fashion.

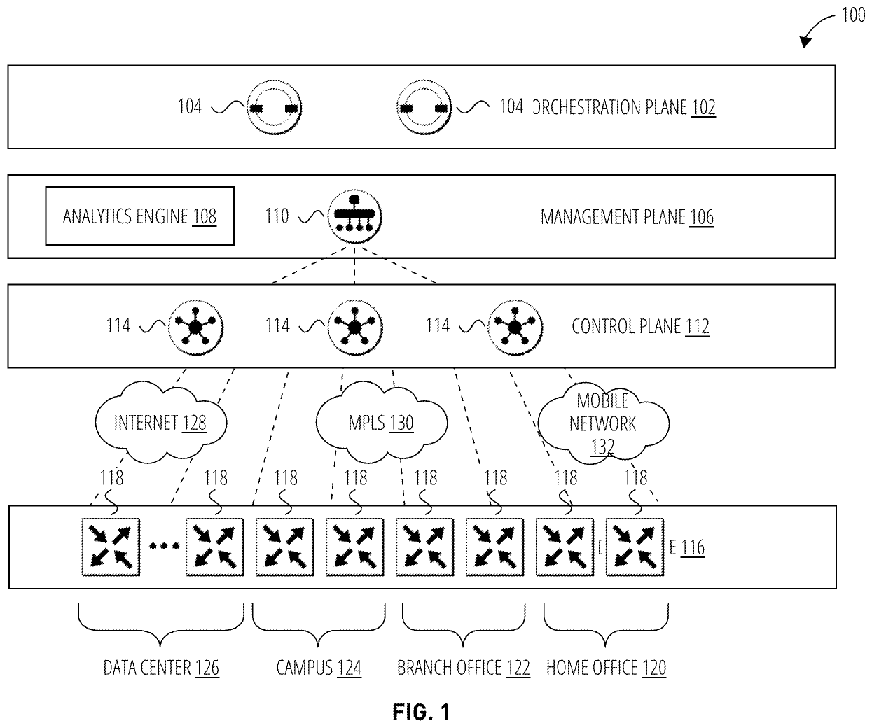

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 106, a control plane 112, and a data plane 116. The orchestration plane 102 can assist in the automatic on-boarding of edge network devices 118 (e.g., switches, routers, etc.) in an overlay network. The orchestration plane 102 can include one or more physical or virtual network orchestrator appliances 104. The network orchestrator appliances 104 can perform the initial authentication of the edge network devices 118 and orchestrate connectivity between devices of the control plane 112 and the data plane 116. In some embodiments, the network orchestrator appliances 104 can also enable communication of devices located behind Network Address Translation (NAT). In some embodiments, physical or virtual Cisco® SD-WAN vBond appliances can operate as the network orchestrator appliances 104.

The management plane 106 can be responsible for central configuration and monitoring of a network. The management plane 106 can include one or more physical or virtual network management appliances 110. In some embodiments, the network management appliances 110 can provide centralized management of the network via a graphical user interface to enable a user to monitor, configure, and maintain the edge network devices 118 and links (e.g., internet transport network 128, MPLS network 130, 4G/Mobile network 132) in an underlay and overlay network. The network management appliances 110 can support multi-tenancy and enable centralized management of logically isolated networks associated with different entities (e.g., enterprises, divisions within enterprises, groups within divisions, etc.). Alternatively, or in addition, the network management appliances 110 can be a dedicated network management system for a single entity. In some embodiments, physical or virtual Cisco® SD-WAN vManage appliances can operate as the network management appliances 110.

The control plane 112 can build and maintain a network topology and make decisions on where traffic flows. The control plane 112 can include one or more physical or virtual network control appliances 114. The network control appliances 114 can establish secure connections to each edge network device 118 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 114 can operate as route reflectors. The network control appliances 114 can also orchestrate secure connectivity in the data plane 116 between and among the edge network devices 118. For example, in some embodiments, the network control appliances 114 can distribute crypto key information among the edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 114.

The data plane 116 can be responsible for forwarding packets based on decisions from the control plane 112. The data plane 116 can include the edge network devices 118, which can be physical or virtual edge network devices. The edge network devices 118 can operate at the edges various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). The edge network devices 118 can provide secure data plane connectivity among sites over one or more WAN transports, such as via one or more internet transport networks 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 118 can be responsible for traffic forwarding, security, encryption, quality of service (QOS), and routing (e.g., BGP, OSPF, etc.), among other tasks. In some embodiments, physical or virtual Cisco® SD-WAN vEdge routers can operate as the edge network devices 118.

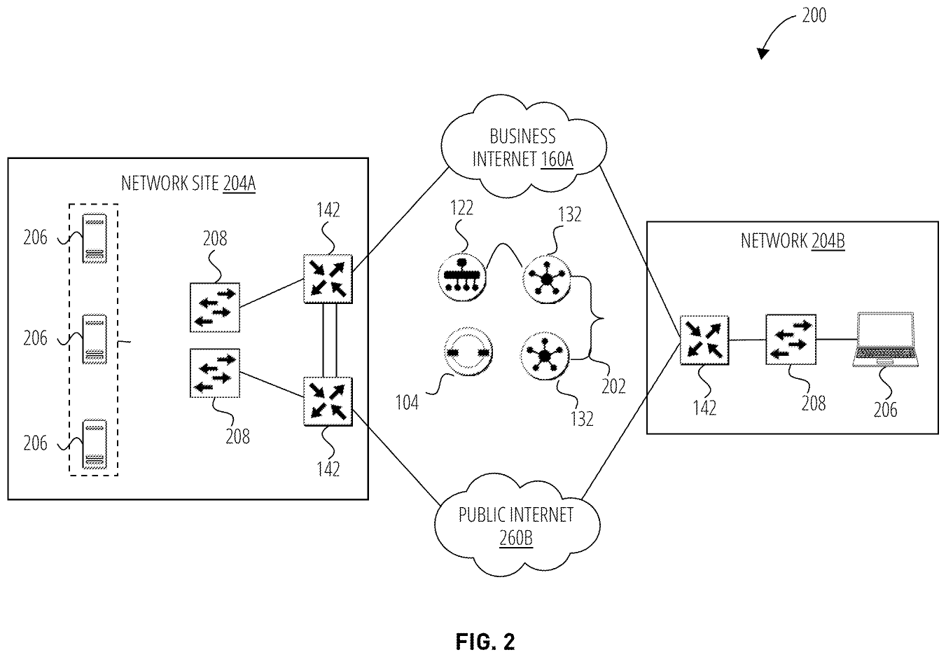

FIG. 2 illustrates an example of a network topology 200 for showing various aspects of the network architecture 100. The network topology 200 can include a management network 202, a pair of network site 204A and 204B (collectively, 204) (e.g., the data center 150, the campus network 152, the branch office network 154, the home office network(s) 156, cloud service provider network(s), etc.), and a pair of Internet transport networks 160A and 160B (collectively, 160). The management network 202 can include one or more network orchestrator appliances 104, branch office networks 122, and mobile network 132. Although the management network 202 is shown as a single network in this example, one of ordinary skill in the art will understand that each element of the management network 202 can be distributed across any number of networks and/or be co-located with the sites 204. In this example, each element of the management network 202 can be reached through either transport network 160A or 160B.

Each site can include one or more endpoint 206 connected to one or more site network device 208, which may also be referred to as an edge device, a network edge device, etc. The endpoint 206 can include general purpose computing devices (e.g., servers, workstations, desktop computers, etc.), mobile computing devices (e.g., laptops, tablets, mobile phones, etc.), wearable devices (e.g., watches, glasses or other head-mounted displays (HMDs), ear devices, etc.), and so forth. The endpoint 206 can also include Internet of Things (IoT) devices or equipment, such as agricultural equipment (e.g., livestock tracking and management systems, watering devices; connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc.); retail equipment (e.g., vending machines, point of sale (POS) devices, Radio Frequency Identification (RFID) tags, etc.); smart city devices (e.g., street lamps, parking meters, waste management sensors, etc.); transportation and logistical equipment (e.g., turnstiles, rental car trackers, navigational devices, inventory monitors, etc.); and so forth.

The site network device 208 can include physical or virtual switches, routers, and other network devices. Although the network site 204A is shown including a pair of site network devices and the site 204B is shown including a single site network device in this example, the site network device 208 can comprise any number of network devices in any network topology, including multi-tier (e.g., core, distribution, and access tiers), spine-and-leaf, mesh, tree, bus, hub and spoke, and so forth. For example, in some embodiments, one or more data center networks may implement the Cisco® Application Centric Infrastructure (ACI) architecture and/or one or more campus networks may implement the Cisco® Software Defined Access (SD-Access or SDA) architecture. The site network device 208 can connect the endpoint 206 to one or more edge network devices 142, and the edge network devices 142 can be used to directly connect to the transport networks 160.

In some embodiments, “color” can be used to identify an individual WAN transport network, and different WAN transport networks may be assigned different colors (e.g., MPLS, private1, biz-internet, metro-ethernet, LTE, etc.). In this example, the network topology 200 can utilize a color called “biz-internet” for the Internet transport network 160A and a color called “public-internet” for the Internet transport network 160B.

In some embodiments, each site network device 208 can form a Datagram Transport Layer Security (DTLS) or TLS control connection to the mobile network 132 and connect to any mobile network 132 over each transport network 160. In some embodiments, the edge network device 142 can also securely connect to edge network devices in other sites via IPSec tunnels. In some embodiments, the BFD protocol may be used within each of these tunnels to detect loss, latency, jitter, and path failures.

On the edge network devices 142, color can be used to help identify or distinguish an individual WAN transport tunnel (e.g., no same color may be used twice on a single edge network device). Colors by themselves can also have significance. For example, the colors metro-ethernet, MPLS, and private1, private2, private3, private4, private5, and private6 may be considered private colors, which can be used for private networks or in places where there is no NAT addressing of the transport IP endpoints (e.g., because there may be no NAT between two endpoints of the same color). When the edge network devices 142 use a private color, they may attempt to build IPSec tunnels to other edge network devices using native, private, underlay IP addresses. The public colors can include 3G, biz, internet, blue, bronze, custom1, custom2, custom3, default, gold, green, LTE, public-internet, red, and silver. The public colors may be used by the edge network devices 142 to build tunnels to post-NAT IP addresses (if there is NAT involved). If the edge network devices 142 use private colors and need NAT to communicate to other private colors, the carrier setting in the configuration can dictate whether the edge network devices 142 use private or public IP addresses. Using this setting, two private colors can establish a session when one or both are using NAT.

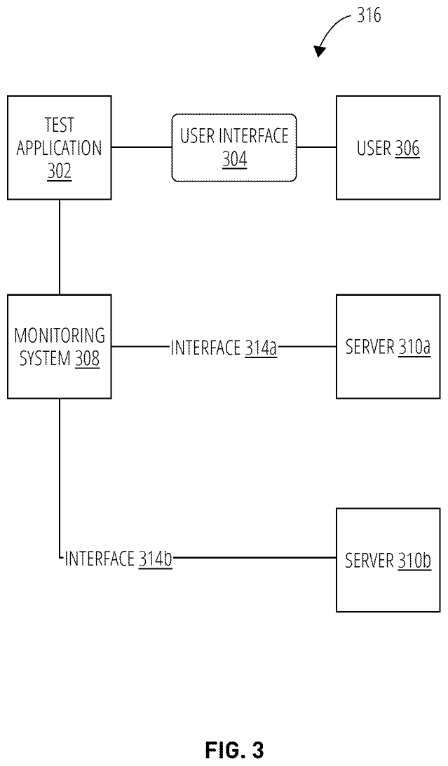

FIG. 3 illustrates an example system configuration for performing chaos simulations and testing network system in accordance with the present disclosure. As shown in FIG. 3, a System configuration 316 includes Test application 302 which is a web service that can be installed on a computing device, such as a server or a working station. Test application 302 provides a User Interface 304. After a User 306 logins with a preconfigured password, User 306 can schedule chaos events. User 306 can also define when these chaos events will be triggered in the future. User 306 can use Test application 302 to perform various simulations. The simulations will be tested by using monitoring system 308 for system efficiency or system resilience in case of unexpected events.

Test application 302 is used to help understand how a network system including servers 310a and 310b or any other computing devices such as workstations, desktop computers, among others, and network interfaces 314a and 314b would behave during unexpected events, regardless of network issues, system load increase, or a complete outage in case of reboots. For example, if some network issues affect one server, a customer with critical services can be affected. Also, Test application 302 is used to help understand how network traffic or network delay affects packet loss, and/or packet corruption, among others.

Test application 302 can be used by the User 306 to inject faults at certain moments. The User 306 can monitor notifications from the monitoring system 308 to see if the monitoring system 308 will notify the User 306 on time to ensure that the monitoring system 308 is efficient.

Technologies involved in the Test application 302 include Golang (Echo Framework), Javascript, Hyper Text Markup Language (HTML) and Cascading Style Sheets (CSS) (VueJs), Linux stress command to manipulate the system load, and Linux traffic control (tc) commands to manipulate the network, among others. CSS is a computer language for laying out and structuring web pages (HTML).

Test application 302 supports the following events including (1) System Load Increase; (2) Network delay; (3) Packet loss; (4) Packet corruption; (5) Packet duplication; (6) Random reboots, among others. Test application 302 also has the ability to schedule these chaos events in the future. The following example procedures describe how Test application 302 is used for simulations of various events.

To simulate system load increase, a user may select the mode type to be system load increase. The user may vary work threads to stress the CPU. For example, a user may select work threads to stress the CPU to be 8, among others. The user may also vary the I/O operations to stress the I/O. The user may also vary workers to allocate memory. For example, the workers to allocate memory may be two, among others. The user may also vary the number of temporary files to perform read/write, for example, three files. The user may also select the local start time and/or the local end time for simulations.

Network delay is the amount of time required for one packet to go from its source to a destination. The network delay may be transmission delay or propagation delay. To simulate network delay, a user may select the mode type to be network delay. The user may select the type of network interface. For example, the network interface may be an Ethernet interface, among others. There may be many Ethernet interfaces, such as a first Ethernet interface (eth0), a second Ethernet interface (eth1), a third Ethernet interface (eth2), etc. The user may select one of the Ethernet interfaces, such as eth0. The user may also vary the delay in millisecond (ms), for example, 100 ms, among others. The user may also vary random uniform distribution in ms, for example, 10 ms, among others. The user may also select the local start time and/or the local end time for simulations.

Packet loss occurs when one or more transmitted data packets fail to arrive at their destinations. The packet loss may cause noticeable performance issues for digital communications. A packet is a small unit of data that a network protocol routes between an origin and a destination on the internet or any other packet-switched network. Network packets hold small amounts of data that typically include information such as the source and destination address, protocols or identification numbers. From sending emails to downloading videos, every internet activity requires the transfer of packets.

To simulate packet loss, a user may select the mode type to be packet loss. The user may select the type of network interface. For example, the network interface may be an Ethernet interface, among others. There may be many Ethernet interfaces, such as a first Ethernet interface (eth0), a second Ethernet interface (eth1), a third Ethernet interface (eth2), etc. The user may also vary the level or degree of packet loss. The level or the degree of packet loss may be represented in percentages, either in fraction or integer, ranging from 0.1% to 99.9%. The user may select a value, such as 10%, among others, for simulation. The user may also select the local start time and the local end time for simulations. The user may vary the level of packet loss, the local start time, and/or the local end time for more simulations.

Packet corruption is a significant source of packet loss. Packet corruption has distinctive symptoms and root causes. To simulate packet corruption, a user may select the mode type to be packet corruption. The user may select the type of network interface. For example, the network interface may be an Ethernet interface, among others. There may be many Ethernet interfaces, such as a first Ethernet interface (eth0), a second Ethernet interface (eth1), a third Ethernet interface (eth2), etc. The user may select one of the Ethernet interfaces, such as eth0. The user may also vary the level or degree of packet corruption. The level or the degree of packet corruption may be represented in percentages, either in fraction or integer. Selection of the percentage can be made, for example the percentage may vary from 0.1% to 99.9%. The user may select a value, such as 5%, among others, for simulation. The user may also select the local start time and the local end time for simulations. The user may vary the level of packet corruption, the local start time, and/or the local end time for more simulations.

Packet duplication is an SD-WAN feature designed to overcome the packet loss in network designs where a WAN edge router has multiple overlay tunnels to the next-hop vEdge router. The SD-WAN feature instructs a WAN edge router to transmit one copy of each packet over multiple IPsec tunnels. If a packet is lost over the transient path, the receiving vEdge router can use another copy of the same packet received over another tunnel. If no packets are lost, all unnecessary duplicates are silently discarded.

To simulate packet duplication, a user may select the mode type to be packet duplication. The user may select the type of network interface. For example, the network interface may be an Ethernet interface, among others. There may be many Ethernet interfaces, such as a first Ethernet interface (eth0), a second Ethernet interface (eth1), a third Ethernet interface (eth2), etc. The user may select one of the Ethernet interfaces, such as eth0. The user may also vary the level or degree of packet corruption. The level or the degree of packet duplication may be represented in percentages, either in fraction or integer, ranging from 0.1% to 99.9%. The user may select a value, such as 5%, among others, for simulation. The user may also select the local start time and the local end time for simulations. The user may vary the level of packet duplication, the local start time, and/or the local end time for more simulations.

To simulate random reboots, a user may select the mode type to be random reboots. The user may select the local start time and/or the local end time for simulations.

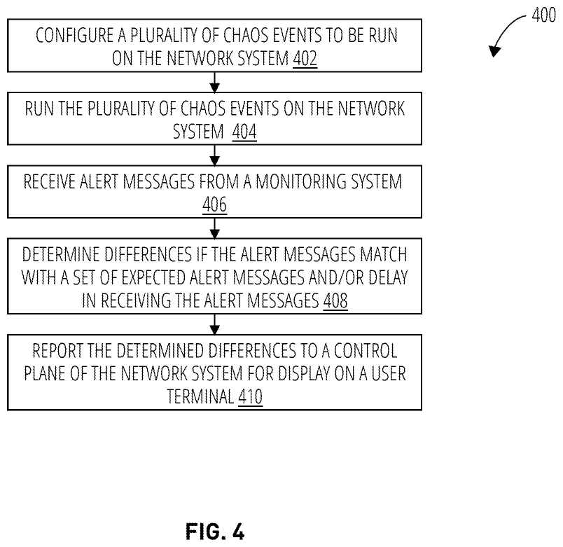

FIG. 4 illustrates an example method for identifying weakness in a network system weakness through simulations in accordance with the present disclosure. In operation 402, method 400 configures a plurality of chaos events to be run on the network system. The network system may include one or more computing devices that are connected through one or more network interfaces. In some variations, the configuring a plurality of chaos events to be run on the network system may include manipulating system load by using stress commands and manipulating network interfaces by using traffic control command. Other technical features may be readily apparent to one skilled in the art from the following figures, descriptions, and claims.

The method 400 may also include pushing the network system to failure by simultaneously adjusting two or more factors including one or more of: varying network traffic, stressing CPU or I/O operations, random rebooting, varying starting time or ending time, changing percentage of the packet corruption, changing the percentage of the packet loss and/or the percentage packet duplication. For example, the user may simultaneously increase the network traffic and increase the percentage packet loss to push the network system to failure. One may vary the starting time or ending time to be in heavy traffic time or low traffic time.

The method 400 may also include defining a plurality of types of modes for the chaos events, which are unexpected events. The plurality of types of modes may include one or more of system load increase, network delay, packet loss, packet corruption, packet duplication, and/or random reboots for the plurality of chaos events.

In operation 404, method 400 includes running the plurality of chaos events on the network system. The plurality of chaos events may include one or more of system load increase, network delay, packet loss, packet corruption, packet duplication, and/or random reboots.

The method 400 may also include defining times when one or more of the pluralities of chaos events are triggered. For example, a user may choose times when network traffic is minimum to prevent users from disruptions so that identification of issues can be linked to accusation. The user may also choose times when network traffic is high to cause network delay.

In operation 406, method 400 receives alert messages from a monitoring system. The monitoring system may be a monitoring and analytics tool and/or software for cloud-scale applications, providing monitoring of servers, databases, tools, and/or services, among others.

The alert messages may have different degrees of urgency for taking actions. In some variations, the alert messages may include error messages or warning messages. For example, the error messages may require immediate attention for system administrators to fix issues in the network system. The warning messages may provide status of the network system and do not require immediate action for system administrators.

In operation 408, method 400 includes determining differences if the alert messages match with a set of expected alert messages and/or delay in receiving the alert messages. For example, Test application 302 generates simulations of a number of pre-determined chaos events at one or more specified time and determines when entries of chaos events may occur. The 308 detects actual chaos events and generates reports of alert messages. Differences may be present between expected entries of chaos events and the actual chaos events. The determined difference between the expected chaos events through simulations and the actual chaos events detected by the monitoring system may cause a delay in reporting of the chaos events. The delay may be determined based on the difference between an expected time from the simulations using Test application 302 and an actual time determined using the monitoring system 308.

In operation 410, method 400 includes reporting the determined differences to a control plane of the network system for display on a user terminal. When the determined differences are reported, network administrator may take actions in fixing the issues which cause the determined differences, such as the delay in reporting.

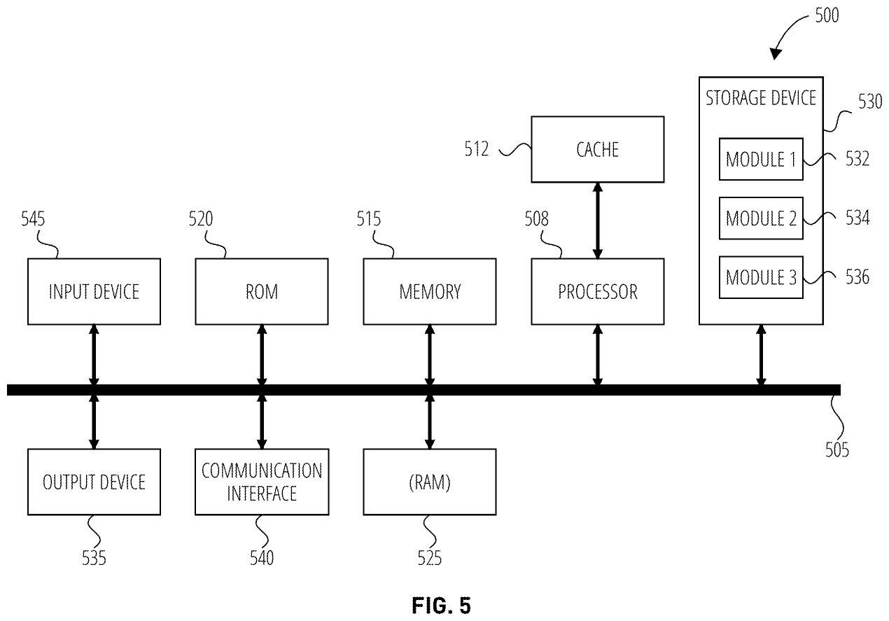

FIG. 5 shows an example of computing system 500, which can be, for example any computing device or any component thereof in which the components of the system are in communication with each other using connection 505. Connection 505 can be a physical connection via a bus, or a direct connection to processor 508, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 508 and connection 505 that couples various system components including memory 515, such as read-only memory (ROM) 520 and random-access memory (RAM) 525 to processor 508. Computing system 500 can include a cache of high-speed memory 512 connected directly with, in close proximity to, or integrated as part of processor 508.

Processor 508 can include any general-purpose processor and a hardware service or software service, such as services 532, 834, and 836 stored in storage device 530, configured to control processor 508 as well as a special-purpose processor where software instructions are incorporated into the actual processor design. Processor 508 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 508, it causes the system to perform a function. In some embodiments, a hardware service that performs a particular function can include the software component stored in a computer-readable medium in connection with the necessary hardware components, such as processor 508, connection 505, output device 535, etc., to carry out the function.

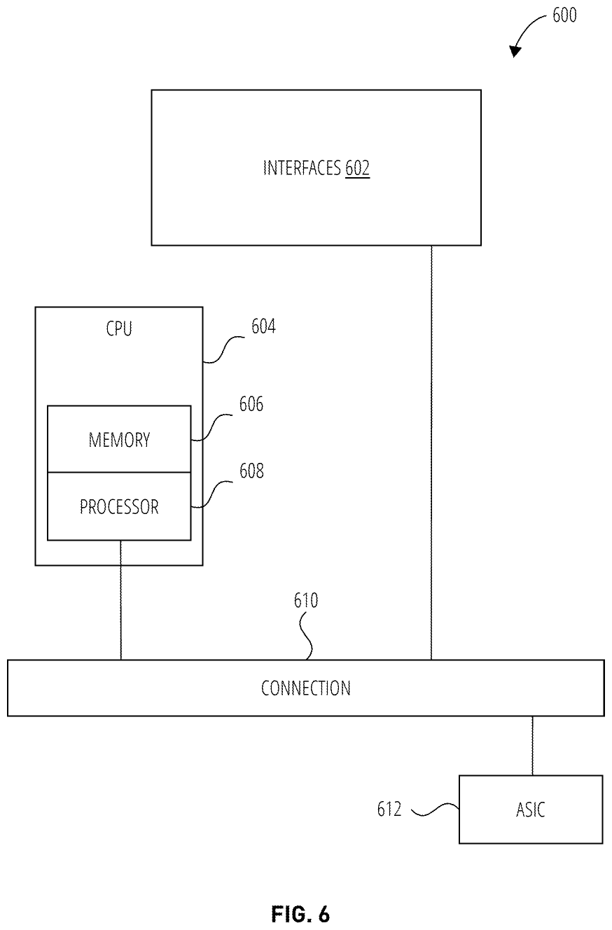

FIG. 6 illustrates an example network device 600 suitable for performing switching, routing, load balancing, and other networking operations. The example network device 600 can be implemented as switches, routers, nodes, metadata servers, load balancers, client devices, and so forth.

Network device 600 includes a central processing unit (CPU) 604, interfaces 602, and a connection bus 610 (e.g., a PCI bus). When acting under the control of appropriate software or firmware, the CPU 604 is responsible for executing packet management, error detection, and/or routing functions. The CPU 604 preferably accomplishes all these functions under the control of software including an operating system and any appropriate applications software. CPU 604 may include one or more processors 608, such as a processor from the INTEL x86 family of microprocessors. In some cases, processor 608 can be specially designed hardware for controlling the operations of network device 600. In some cases, a memory 606 (e.g., non-volatile RAM, ROM, etc.) also forms part of CPU 604. However, there are many different ways in which memory could be coupled to the system.

The interfaces 602 are typically provided as modular interface cards (sometimes referred to as “line cards”). Generally, they control the sending and receiving of data packets over the network and sometimes support other peripherals used with the network device 600. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communication intensive tasks, these interfaces allow the master CPU (e.g., 604) to efficiently perform routing computations, network diagnostics, security functions, etc.

Although the system shown in FIG. 6 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 600.

Regardless of the network device's configuration, it may employ one or more memories or memory modules (including memory 606) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 606 could also hold various software containers and virtualized execution environments and data.

The network device 600 can also include an application-specific integrated circuit (ASIC) 612, which can be configured to perform routing and/or switching operations. The ASIC 612 can communicate with other components in the network device 600 via the bus 610, to exchange data and signals and coordinate various types of operations by the network device 600, such as routing, switching, and/or data storage operations, for example.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method for identifying one or more weakness in a network system through simulations comprising:
configuring a plurality of chaos events to be run on the network system;
running the plurality of chaos events on the network system;
in response to the plurality of chaos events running on the network system, receiving alert messages from a monitoring system, wherein the alert messages are generated in response to errors or warnings during the plurality of chaos events running on the network system;
determining differences when the alert messages match with a set of expected alert messages or a delay in receiving the alert messages, wherein the set of expected alert messages are errors or warnings expected in response to the plurality of chaos events running on the network system; and
reporting determined differences to a control plane of the network system for display on a user terminal.

2. The method of claim 1, wherein the configuring a plurality of chaos events to be run on the network system comprises:
manipulating system load by using stress commands; and
manipulating network interfaces by using traffic control command.

3. The method of claim 1, further comprising pushing the network system to failure by simultaneously adjusting two or more factors including one or more of: varying network traffic, stressing CPU or I/O operations, random rebooting, varying starting time or ending time, changing percentage of packet corruption, changing the percentage of packet loss and/or percentage packet duplication.

4. The method of claim 1, further comprising defining times when one or more of the plurality of chaos events are triggered.

5. The method of claim 4, wherein the times are selected to be when network traffic is low to prevent disruptions to users.

6. The method of claim 1, further comprising defining a plurality of types of modes for the plurality of chaos events.

7. The method of claim 6, wherein the plurality of types of modes comprises one or more of system load increase, network delay, packet loss, packet corruption, packet duplication, and/or random reboots for the plurality of chaos events.

8. The method of claim 7, wherein the plurality of chaos events comprises one or more of system load increase, network delay, packet loss, packet corruption, packet duplication, and/or random reboots.

9. The method of claim 1, wherein the network system comprises one or more computing devices that are connected through one or more network interfaces.

10. The method of claim 1, wherein the alert messages comprise error messages or warning messages.

11. A computing apparatus comprising:
a processor;
memory storing instructions that, when executed by the processor, configure the computing apparatus to:
configure a plurality of chaos events to be run on a network system;
run the plurality of chaos events on the network system;
in response to the plurality of chaos events running on the network system, receive alert messages from a monitoring system, wherein the alert messages are generated in response to errors or warnings during the plurality of chaos events running on the network system;
determine differences when the alert messages match with a set of expected alert messages or a delay in receiving the alert messages, wherein the set of expected alert messages are errors or warnings expected in response to the plurality of chaos events running on the network system; and
report determined differences to a control plane of the network system for display on a user terminal.

12. The computing apparatus of claim 11, wherein to configure a plurality of chaos events to be run on the network system comprises:
manipulate system load by using stress commands; and
manipulate network interfaces by using traffic control command.

13. The computing apparatus of claim 11, wherein the memory storing instructions that, when executed by the processor, configure the computing apparatus to push the network system to failure by simultaneously adjusting two or more factors including one or more of: varying network traffic, stressing CPU or I/O operations, random rebooting, varying starting time or ending time, changing percentage of packet corruption, changing the percentage of packet loss and/or percentage packet duplication.

14. The computing apparatus of claim 11, wherein the network system comprises one or more computing devices that are connected through one or more network interfaces.

15. A non-transitory computer-readable storage medium, wherein the non-transitory computer-readable storage medium including instructions that when executed by a computer, cause the computer to:
configure a plurality of chaos events to be run on a network system;
run the plurality of chaos events on the network system;
in response to the plurality of chaos events running on the network system, receive alert messages from a monitoring system, wherein the alert messages are generated in response to errors or warnings during the plurality of chaos events running on the network system;
determine differences when the alert messages match with a set of expected alert messages or a delay in receiving the alert messages, wherein the set of expected alert messages are errors or warnings expected in response to the plurality of chaos events running on the network system; and
report determined differences to a control plane of the network system for display on a user terminal.

16. The non-transitory computer-readable storage medium of claim 15, wherein the non-transitory computer-readable storage medium including instructions that when executed by a computer, cause the computer to push the network system to failure by simultaneously adjusting two or more factors including one or more of: varying network traffic, stressing CPU or I/O operations, random rebooting, varying starting time or ending time, changing percentage of packet corruption, changing the percentage of packet loss and/or percentage packet duplication.

17. The non-transitory computer-readable storage medium of claim 15, wherein the non-transitory computer-readable storage medium including instructions that when executed by a computer, cause the computer to manipulate system load by using stress commands; and manipulate network interfaces by using traffic control command.

18. The non-transitory computer-readable storage medium of claim 15, wherein the non-transitory computer-readable storage medium including instructions that when executed by a computer, cause the computer to define times when one or more of the plurality of chaos events are triggered.

19. The non-transitory computer-readable storage medium of claim 15, wherein the non-transitory computer-readable storage medium including instructions that when executed by a computer, cause the computer to define a plurality of types of modes for the plurality of chaos events.

20. The non-transitory computer-readable storage medium of claim 15, wherein the network system comprises one or more computing devices that are connected through one or more network interfaces.
